(19) United States
(12) Patent Application Publication
(10) Pub. No.: US 2007/0085244 A1
(43) Pub. Date: Apr. 19, 2007

(54) Method for making inflatable hollow bodies

(75) Inventor: Chul Hi Park, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Chul Hi Park, San Jose, CA (US)

(21) Appl. No.: 11/582,098

(22) Filed: Oct. 16, 2006

Related U.S. Application Data
(60) Provisional application No. 60/727,910, filed on Oct. 17, 2005.

(51) Int. Cl. B29C 49/00

(52) U.S. Cl. 264/523

(57) ABSTRACT

An inflatable hollow body of a complex configuration is manufactured by blow molding a tubular preform using a mold with a cavity configured to correspond to the hollow body in an inflated state. In a preferred embodiment, the mold comprises a plurality of mold body portions, each mold body portion having a cavity portion, which together with other cavity portions forms a single continuous cavity of the mold. The preferred method of manufacture comprises providing a tubular preform and a mold, fitting the tubular preform in the cavity of the mold, heating the mold to a drawing temperature, drawing the tubular preform, heating the mold to a blowing temperature, inflating the tubular preform, cooling the mold, deflating and releasing manufactured hollow body from the mold.

### CROSS-REFERENCES TO RELATED APPLICATIONS

This application claims priority to U.S. Provisional Patent Application No. 60/727,910, filed on Oct. 17, 2005, which is incorporated by reference herein for all purposes.

### BACKGROUND OF THE INVENTION

The present invention relates to a method for manufacturing inflatable hollow bodies of complex configuration and of thermoplastic material, more particularly, to tubular bodies with the direction of main axis continually varying in space.

Inflatable hollow bodies of curved configurations find many applications in medical and other fields. U.S. Pat. No. 4,183,102 describes inflatable prosthetic devices for use in vascular surgeries. U.S. Pat. No. 5,226,888 describes perfusion balloon catheters for use in angioplasty procedures. U.S. Pat. App. Pub. No. US 2004/0254625 describes inflatable implants suitable for placement in the human body. U.S. Pat. App. Pub. No. US 2006/0047183 describes inflatable guide devices for use in colonoscopy procedures. All of the above are incorporated by reference.

Generally being constructed out of tubular members of thermoplastic materials, the configurations of these devices in a fully inflated state can be commonly characterized as having a plurality of axes arranged at angles and spatially with one another or an axis tracing a complex three dimensional curve with continually varying curvature. The capability of being deflated into a low profile form and inflated back into a full configuration is one of the key characteristics that make these devices so useful in medical applications. Typically, these devices are introduced into patient's body through an opening, for example, anus or surgically created access port, in deflated and folded state in a low profile form to minimize patient discomfort or insertion wounds and to facilitate maneuver through often a tortuous passage leading to the site of interest inside the patient's body. Once positioned at the location of interest, these devices are inflated by introducing a pressurizing fluid supplied through a small diameter supply tube connected to the tubular member outside the patient. The design of these devices and the characteristics of material used to build them are such that these devices acquire certain mechanical characteristics desirable for intended applications when inflated under predetermined internal pressure. At the completion of the procedure these devices are deflated back to a low profile form by withdrawing the pressurizing fluid through the supply tube out of the tubular member and removed from the patient. For certain applications these devices may be left at the site of interest for an extended period of time.

The wall of these devices should be as thin as practically allowable to minimize profile when they are deflated and folded for deployment and retrieval. The material used to build these devices should be flexible and soft to facilitate the inflation and deflation by the introduction and withdrawal of a pressurizing fluid. The construction material should be stiff or of high tensile strength, even when very thin, to prevent these devices from deviating from predetermined configurations even under high internal pressure that may be required in certain applications. Materials that satisfy these and additional requirements associated with manufacturing processes include biocompatible thermoplastic resins, for example, polyethylene terephthalate (PET), polypropylene, polyurethane, polyamide (Nylon), polyvinylchloride (PVC) and polyethylene that have seen wide spread applications in medical fields.

Generally hollow plastic bodies are produced using blow molding processes. In a conventional blow molding process the starting plastic material which is plasticized in an extruder by the action of pressure and heat is molded in a so-called “blow head” downstream of the extruder into a tubular skin, often referred as parison, and squeezed vertically downwards from the nozzle of the blow head. Sections of extruded material are introduced individually as parisons into the mold cavity of a divided and opened two-piece blow mold. After the blow mold has been closed the parisons are expanded into hollow plastic bodies of the desired shape, defined by the shape of the mold cavity, by introducing a blow medium by means of a blowing needle until contact is established with the wall of the mold cavity. Upon contact with the wall of the mold cavity, which is kept cool by a cooling medium, the formed plastic bodies quickly cool down below a predetermined temperature. Below this temperature the plastic bodies lose plasticity and remain fixed in their shapes when released from the blow mold.

Conventional blow molding processes are useful in the production of hollow thermoplastic bodies with relatively simple configurations, for example, rotationally symmetrical bodies or such bodies that have simple main axis only, e.g. bottles, canisters, wide-necked vessels. The configurations of cavities that correspond to the outside surface contours of these bodies are correspondingly simple. The construction of blow molds typically employed for manufacturing these bodies are also simple usually involving two pieces of mold halves that open and close horizontally.

Certain complex configurations, e.g., the inflatable hollow plastic bodies described previously, may not be well suited for production by conventional blow molding processes. The mold required to produce these bodies can be generally much more complicated than two-piece mold typically employed in producing conventional hollow bodies. The shape of a mold cavity, which is configured to correspond to that of a hollow body being blow molded, may be too complicated to be machined into a two-piece mold in a way that a conventional blow molding processes can be applied. Even when such mold cavity can be produced fitting a thin-walled tubular parison, in soft state having been just extruded out of the extruder head, into a highly curved cavity poses a considerable technical challenge because of its tendency to collapse onto itself and to kink especially around bends in the cavity in the course of maneuver to place it into the mold cavity.

### BRIEF SUMMARY OF THE INVENTION

The present invention relates to inflatable hollow bodies of complex configuration. An embodiment of the invention is directed to a mold for manufacture of inflatable hollow bodies of complex configuration. The mold has a plurality of mold body portions configured to mate with at least one other mold body portion to produce an assembled mold having a cavity. The cavity is configured to correspond to the inflatable hollow bodies in an inflated state. In one implementation, a method for manufacturing inflatable hollow thermoplastic bodies of complex configurations is provided. The bodies of complex configurations have a plurality of axes arranged at angles and spatially with one another or an axis tracing a complex three dimensional curve with continually varying curvature.

According to one aspect of the invention, a method for manufacturing inflatable hollow plastic bodies of complex configuration includes the steps of providing a tubular preform of a selected thermoplastic material of wall thickness and diameter suitable for being blow molded into such bodies, providing a mold with a cavity configured to correspond to the hollow body in an inflated state to be manufactured, fitting the tubular preform into the cavity of the mold, heating the mold and the tubular preform to predetermined drawing temperature, drawing the tubular preform, heating the mold and the drawn tubular preform to predetermined blowing temperature, forming the hollow body by blowing the drawn tube with a pressurized fluid, cooling the mold and the manufactured hollow body, and releasing the hollow body from the mold. Alternatively, a tubular preform may be drawn at a predetermined drawing temperature prior to the blow molding processes. Alternatively, the drawing process may be entirely omitted.

### BRIEF DESCRIPTION OF THE DRAWINGS

The following exemplary figures are provided to supplement the description below and more clearly describe the invention. In the figures, like elements are generally designated with the same reference numeral for illustrative convenience and should not be used to limit the scope of the present invention.

FIG. 1 schematically shows an example of a section of an inflatable hollow body of complex configuration in an inflated state.

FIGS. 2A and 2B are schematic views of an inner mold body portion of a mold for the manufacture of the hollow body shown in FIG. 1 from two opposing angles.

FIG. 3 schematically shows two outer mold body portions of a mold for the manufacture of the hollow body shown in FIG. 1.

FIG. 4 is a schematic assembly diagram of the mold for the manufacture of the hollow body shown in FIG. 1.

FIGS. 5A-5C schematically show, in time sequence, a tubular preform being fitted into the cavity of the inner mold body portion.

FIG. 6 schematically shows the inner mold body portion fitted with the tubular preform and engaged with one of the outer mold body portions prior to expansion.

FIG. 7 is a cross sectional view of the tubular preform wall being expanded in the cavity of the mold, as indicated by arrows, by a pressurizing fluid.

FIG. 8 schematically shows the inner mold body portion with manufactured hollow body engaged with one of the outer mold body portions.

### DETAILED DESCRIPTION OF THE INVENTION

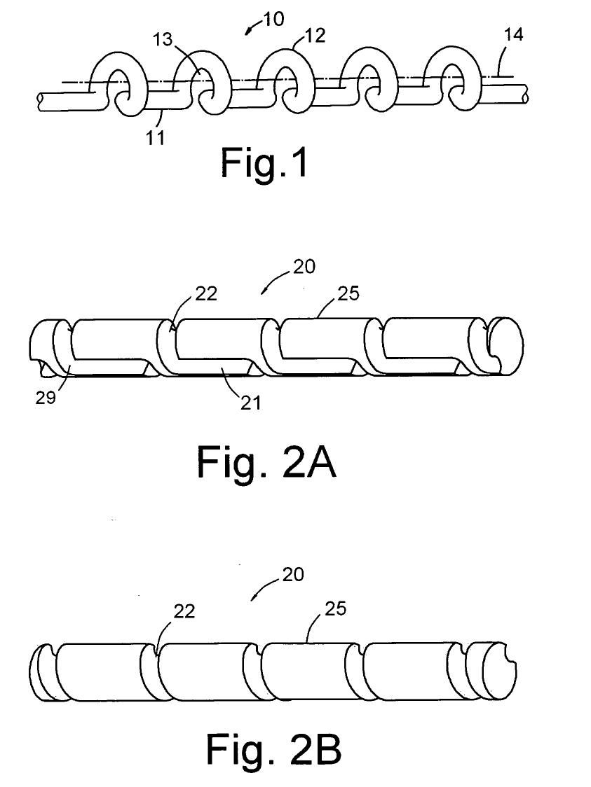

Referring to FIG. 1, an example of a section of an inflatable hollow body 10 of thermoplastic material and of complex configuration in fully inflated state is shown. Hollow body 10 generally comprises a continuous, collapsible tubular member consisting straight 11 and looped sections 12 disposed in predetermined positions along the length thereof. The main axis of the tubular member comprising hollow body 10 traces a complex curve of continuously varying direction in three-dimensional space. In conventional blow molding process for manufacturing a hollow body, a mold composed of two mold body portions is typically employed. A partying plane or surface between the two mold body portions is arranged to roughly bisect the cavity volume that is configured to correspond to the hollow body in an expanded state so that manufactured product may be spontaneously disengaged from the cavity without need for further intervention as two mold body portions separate and move away from each other. The complex geometry of hollow body 10 precludes defining such simple partying plane or surface and generally, a conventional blow molding mold comprising two mold body portions is not well suited for manufacturing such hollow bodies of complex configurations.

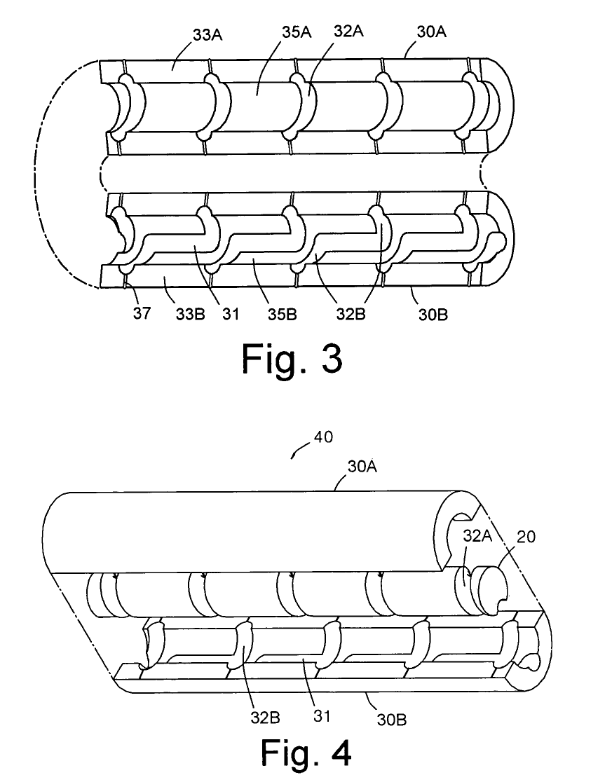

Referring to FIGS. 2-4, a preferred embodiment of a blow molding mold for the manufacture of hollow body 10 in FIG. 1 is shown. A mold 40 comprises three mold body portions, an inner mold body portion 20 and two outer mold body portions 30A and 30B (see FIG. 4). Inner mold body portion 20 is configured to mate with two outer mold body portions 30A and 30B. As shown in FIGS. 2A and 2B in two opposing view angles, generally cylindrical inner mold body portion 20 has a continuous channel cavity 29 disposed on its outside surface contour 25. A straight portion 21 of channel cavity 29 is configured to correspond to the inner half of the outside surface contour of straight section 11 of hollow body 10 shown in FIG. 1, that is, the part of the surface that generally faces toward an axis 14 passing through the centers of holes 13 in looped sections 12, represented as a dotted line in FIG. 1. Similarly, a circumferential portion 22 of channel cavity 29 is configured to correspond to the inner half of the outside surface contour of looped section 12. As shown in FIG. 3, two outer mold body portions 30A and 30B have cylindrical inside surface contours 35A and 35B that are configured to correspond to and come in contact with, when mated, cylindrical outside surface contour 25 of inner mold body portion 20. A plurality of channel cavities 31, 32A and 32B are disposed on cylindrical inside surface contours 35A and 35B. When two outer mold body portions 30A and 30B are mated as shown in FIG. 4, channel cavities 31, 32A and 32B form a continuous channel cavity that is configured to correspond to the outer half of the outside surface contour of hollow body 10 shown in FIG. 1, that is, the part of the surface that generally faces away from axis 14. When mated as shown in FIG. 4, the orientation of inner mold body portion 20 with respect to outer mold body portions 30A and 30B is such that the channel cavity of inner mold body portion 20 aligns with that of outer mold body portions 30A and 30B to form a continuous, tubular cavity that corresponds to the surface contour of hollow body 10 in an inflated state as shown in FIG. 1.

Referring to FIG. 3, first outer mold body portion 30A has a contact surface 33A that is configured to mate with a contact surface 33B of second outer mold body portion 30B. A plurality of exhaust channels 37 are formed in contact surfaces 33A, 33B extending from circumferential channel cavity 32A, 32B to a position outside the mold. Exhaust channels 37 allow air trapped in the tubular channel cavity during expansion of tubular preform to escape facilitating the inflation of tubular preform. Exhaust channels 37 are configured to longitudinally align with circumferential channel cavities 32A, 32B.

Mold 40 shown in FIGS. 2-4 includes three mold body portions 20, 30A and 30B. However, other embodiments may include a plurality of mold body portions with at least one of the mold body portions configured to mate with at least one of the other mold body portions to form an assembled mold enclosing a cavity that is configured to correspond to a hollow body in an inflated state to be manufactured through a blow molding process.

Mold 40 can have any length necessary for the manufacture of hollow body 10 shown in FIG. 1. Inner mold body portion 20 also can have any transverse dimension necessary for the manufacture of hollow body 10. Mold body portions 20, 30A and 30B may be made of any metal typically used in conventional blow molding processes such as steel, aluminum, brass or metal alloys of high thermal conductivity.

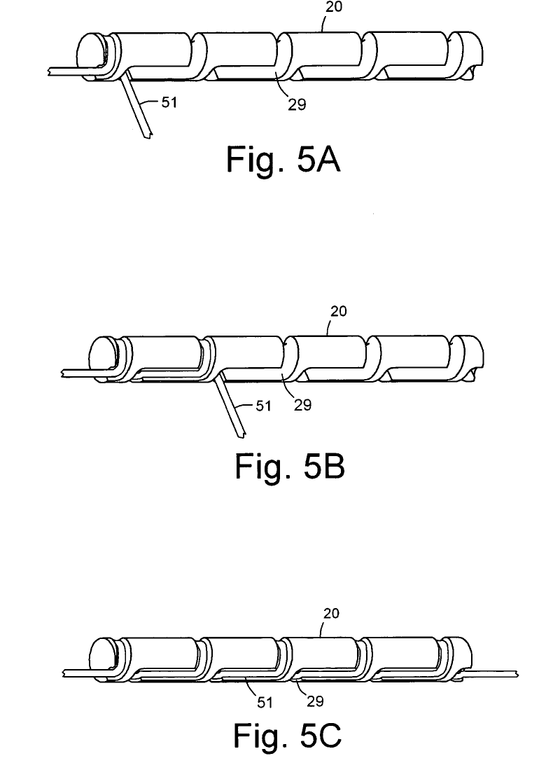

FIGS. 5-8 show the components and the steps necessary to manufacture the inflatable hollow plastic bodies of complex configurations shown in FIG. 1. The method of the present invention is described in detail below generally following sequential order of processes.

Referring to FIGS. 5A-5C, a length of flexible tubular preform 51 is fitted into channel cavity 29 on inner mold body portion 20 to closely conform to the surface contour of channel cavity 29. Tubular preform 51 may be made of any thermoplastic material suitable for blow molding process, for example, polyethylene terephthalate (PET), polypropylene (PP), polyamide (Nylon), and polyvinylchloride (PVC). The wall thickness of tubular preform 51 may be between 0.005 mm and 0.25 mm. The diameter of tubular preform 51 may be between 1 mm and 10 mm. Throughout the fitting process a tension of predetermined magnitude is maintained on tubular preform 51 so that the fitted portion can remain tautly held within channel cavity 29 along the straight and around the circumferential portions of channel cavity 29.

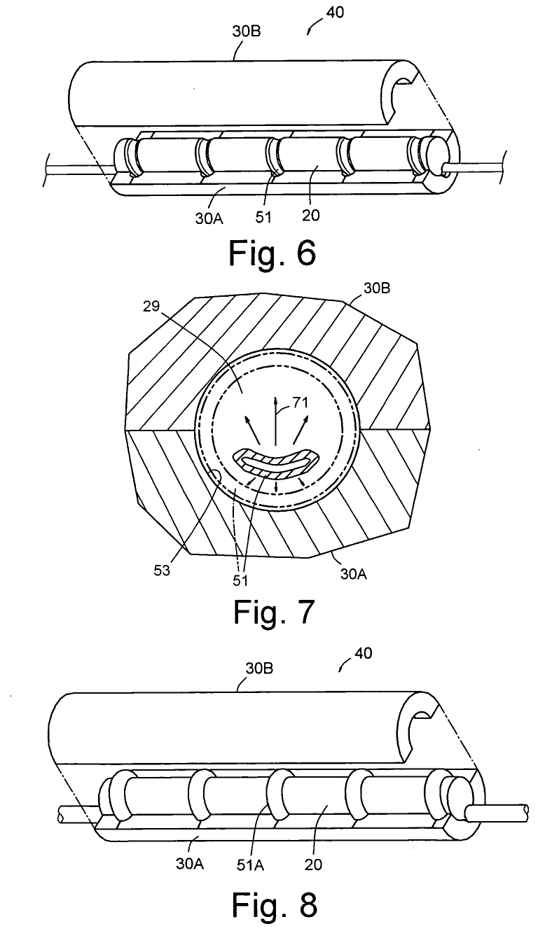

After fitting process, the mold 40 is assembled by closing two outer mold body portions 30A and 30B around inner mold body portion 20. FIG. 6 schematically shows inner mold body portion 20 fitted with tubular preform 51 and engaged with one of outer mold body portions prior to blowing process. The other outer mold body portion is depicted separated from the mold for clarity of illustration. Mold 40 together with tubular perform 51 is heated by an external heating means (not shown) to a predetermined drawing temperature, which, for a tubular preform made of PET, is selected from the range of about 105 to 130 degrees centigrade. Any suitable external heating means may be employed for heating mold 40 such as readily available band-type or cartridge-type electrical heater controlled with a closed-loop temperature control instrument. Fitted tubular perform 51 is then stretched lengthwise by applying a tension on both ends of tubular preform 51 to cause the molecules of the perform material to be axially oriented along the length of the preform prior to blowing process. Alternatively, tubular perform 51 may be pre-stretched under similar temperature condition to cause the axial orientation of molecules prior to the blow molding process. Alternatively, the stretching process may be entirely omitted.

Mold 40 is brought to a predetermined blowing temperature. For a tubular preform made of PET this temperature is between about 85 and 115 degrees centigrade. Referring to FIG. 7, a cross sectional view of tubular preform 51 fitted into the cavity is schematically shown being blown or expanded by the action of the internal pressure, represented by arrows 71, provided by a pressurizing fluid to fully inflated state represented by phantom lines. One end of fitted tubular preform 51 is sealed airtight and the fitted tubular preform is expanded by a pressurizing fluid supplied through the open end opposite to the sealed end until expanding outside surface of tubular preform 51 reaches inside surface 53 of cavity 29 of mold assembly 40. The pressurizing fluid may be air, nitrogen, water, saline solution or any other suitable material. The pressurizing fluid may be heated to a temperature close to the blowing temperature prior to use in the blowing process. The pressure applied may be between 2 atmosphere and 15 atmosphere.

Referring to FIG. 8, which schematically shows mold 40 with manufactured hollow body 51A in an expanded state. After the blowing process, mold 40 and expanded hollow body 51A are cooled to room temperature preferably with the aid of an external cooling means, not shown. During cooling process the internal pressure in expanded hollow body 51A is maintained above ambient pressure to prevent the collapse of hollow body 51A.

Internal pressure is removed from manufactured hollow body 5 lA to cause it to deflate and become flexible in order to release it from the cavity of inner mold body portions 20 after mold 40 is disassembled.

While preferred illustrative embodiments of the invention are described above, it will be apparent to those skilled in the art that various changes and modifications may be made therein without departing from the invention. Accordingly, the appended claims should be used to interpret the scope of the present invention.

What is claimed is:

1. A method for manufacturing an inflatable, hollow plastic body, the method comprising:
providing a tubular preform of a selected thermoplastic material for being blow molded into the body;
providing a mold with a cavity configured to correspond to the hollow body in an inflated state to be manufactured;
fitting the tubular preform into the cavity of the mold;
heating the mold and the tubular preform to a given blowing temperature;
providing a pressurized fluid within the tubular perform to form the hollow body;
cooling the mold and the manufactured hollow body; and
releasing the hollow body from the mold.

2. The method of claim 1, further comprising:
heating the mold and the tubular preform to a given drawing temperature; and
drawing the tubular perform.

3. The method of claim 1, wherein the tubular preform is drawn at the predetermined drawing temperature prior to being provided the fitting step.

4. The method of claim 1, wherein tubular perform is no more than 0.25 mm thick.

5. The method of claim 1, wherein a diameter of the tubular perform is no more than 10 mm.

6. The method of claim 1, wherein the mold comprises a plurality of body portions.

7. The method of claim 1, wherein the tubular perform is maintained at a given tension during the fitting step.

8. The method of claim 1, wherein the pressurizing fluid is heated prior to being provided within the tubular perform.

9. The method of claim 1, wherein the tubular preform is made of thermoplastic material selected from the group consisting of polyethylene terephthalate (PET), polypropylene, polyurethane, polyamide (Nylon), polyvinylchloride (PVC) and polyethylene.

10. A method for manufacturing an inflatable, hollow plastic body, the method comprising:
providing a flexible perform;
providing a mold comprising a plurality of body portions, the mold having a cavity;
mating the perform with the cavity of the mold;
pressurizing the perform to produce a hollow body that is configured to be inflated to a predetermined shape; and
releasing the hollow body from the mold.

11. The method of claim 10, wherein the flexible perform has a thickness of no more than 0.25 mm.

12. The method of claim 10, wherein the mold comprises two or more body portions.

13. The method of claim 10, further comprising:
heating the mold and the tubular preform to a drawing temperature; and
drawing the tubular perform.

14. The method of claim 10, further comprising:
heating the mold and the tubular preform to a blowing temperature prior to blow molding.

15. The method of claim 10, further comprising:
applying a tension to the perform during the mating step.

16. The method of claim 10, wherein the tubular preform is drawn at the drawing temperature prior to the mating step.
